(19) United States
(12) Patent Application Publication
(10) Pub. No.: US 2026/0309613 A1
(43) Pub. Date: Oct. 8, 2026

(54) SYSTEM FOR REDUCING OR OPTIMIZING THE ELECTRICAL CONSUMPTION OR PRODUCTION OF FLUIDIC EQUIPMENT WITH AT LEAST ONE ROTARY COMPONENT

(71) Applicant: COMMISSARIAT A L'ENERGIE ATOMIQUE ET AUX ENERGIES ALTERNATIVES, Paris (FR)

(72) Inventor: Mathieu DARNAJOU, PERTUIS (FR)

(21) Appl. No.: 19/108,372

(22) PCT Filed: Sep. 6, 2024
(86) PCT No.: PCT/EP2024/074911

§ 371 Date: Mar. 3, 2025

(30) Foreign Application Priority Data
Sep. 6, 2023 (FR) FR2309345

(51) Int. Cl. G01N 15/12; G01N 15/00; G01N 15/1433

(52) U.S. Cl. CPC G01N 15/132; G01N 15/1433; G01N 2015/0011; G01N 2015/133; G01N 2015/135

(57) ABSTRACT

A system for reducing or optimizing the electrical consumption or production of fluidic equipment with at least one rotary component, including at least one electrical sensor with electrodes distributed around a body of the equipment, with the end of said electrodes being flush with the internal surface of the body and facing the component; an electronic circuit for controlling the electrodes and for tomographic measurement by electrical impedance; a signal processing unit, adapted to reconstruct images of the fluid in the body from measurements of matrices; an electronic unit for automatically controlling the component for controlling the equipment, adapted to modify the operating frequency of the equipment so as to adjust its electrical power and therefore its flow rate:power ratio.

### TECHNICAL FIELD

The present invention relates to the field of monitoring fluidic equipment intended to be implemented in a fluidic circuit, notably in an industrial facility.

The invention more specifically relates to the detection of air bubbles, the presence of which is due to a phenomenon, called cavitation, in a fluid flowing in a fluidic circuit that is capable of causing excess electrical consumption or excess electrical production by fluidic equipment with a rotary component in said circuit.

Although described with reference to an application for monitoring pumps, the invention can be applied to monitoring any type of fluidic equipment with a rotary component and/or that is likely to create a drop in pressure leading to cavitation, such as a turbine, likely to be present in a fluidic circuit, notably in an industrial facility.

“Fluidic equipment” is understood herein, and within the context of the invention, to mean at least one rotary component or set of electromechanical components likely to be implemented in a fluidic circuit, and adapted to be electrically powered or to produce electricity. This involves an active device, for which at least one rotary component continuously and/or discontinuously (pump, marine propulsion) moves volumes of fluid or uses the force of a fluid (turbine).

### PRIOR ART

Pumps are a key component of industrial facilities, and are currently the second most manufactured device in the world after electric motors.

Pumps convey the fluids needed for human activities, notably industrial activities, such as most raw materials, water, the fluids used in the agri-foodstuffs, chemical, pharmaceutical, construction, paper, electronics, mining and fossil fuel industries, etc.

Cavitation phenomena, i.e., the presence of vapor bubbles created by excessive suction power or by the absence of fluid at the suction point of a pump, can result in excessive electricity consumption or can even cause the pump to break.

In order to address this problem, the pumps can be dismantled and parts can be replaced or cleaned within the context of scheduled maintenance. However, this can lead to unnecessary expense, since, in order to be safe, the pumps must be serviced more frequently than is actually necessary.

A significant number of systems exist for monitoring fluidic circuits incorporating one or more pumps.

They are mainly based on measurements of pressure differences, vibrations, infrared or ultrasound measurements, as described in patent applications/patents FR 3026443 A1, CN 111197581 A and EP 1297331 B1, respectively.

These existing systems do not allow electrical over-consumption or, conversely, electrical under-consumption, or even pump breakages to be effectively anticipated.

In particular, although some of the implemented commercial solutions can detect a high degree of cavitation, they can be complex to implement and are specific to certain types of pumps.

Consequently, a requirement exists for a pump monitoring system in a fluidic circuit that overcomes the disadvantages of the known systems, notably in order to allow cavitation to be detected simply and for all types of pumps, in order to optimize the electrical consumption of the pump and, in any case, to prevent pumps from breaking due to cavitation.

More generally, a requirement exists for a system for monitoring fluidic equipment with at least one rotary component implemented in a fluidic circuit, which is capable of simply detecting cavitation in order to optimize the electrical consumption or production of the equipment and, in any case, to prevent equipment from breaking due to cavitation.

The aim of the invention is to at least partially address these requirements.

### DISCLOSURE OF THE INVENTION

To this end, the aim of the invention, according to one of the aspects thereof, is a system for reducing or optimizing the electrical consumption or the electrical production of fluidic equipment with at least one rotary component, adapted to be electrically powered or to produce electricity, comprising:
at least one electrical sensor comprising a plurality of electrodes distributed around a body of the fluidic equipment, with the end of said electrodes being flush with the internal surface of the body and facing the rotary component;
an electronic circuit for controlling the electrodes and for tomographic measurement by electrical impedance, the circuit being adapted to respectively simultaneously excite the electrodes and to measure electrical impedance matrices of the fluid flow comprising, if applicable, cavitation bubbles in the body;
a signal processing unit, adapted to reconstruct images of the fluid flow in the body from the measurements of impedance matrices of the electronic circuit;
an electronic unit for automatically controlling the component for controlling the fluidic equipment, adapted to modify the operating frequency of the equipment so as to adjust its electrical operating power and thus adjust its flow rate:power ratio.

According to an alternative embodiment, the fluidic equipment is a pump or a turbine, with the end of the electrodes facing the free end of the blades of the pump or the turbine or being integrated with them, the control component being a frequency variator.

Advantageously, the operation of the electronic unit for automatically controlling the fluidic equipment is slaved to that of the signal processing unit.

According to an advantageous construction mode, the system comprises a casing fixed around the body of the fluidic equipment, housing the electrical sensor with the electrodes being individually sealably housed and fixed in a through hole of the body.

Preferably, the casing houses an electrical power supply port for the electrodes.

According to an advantageous alternative embodiment, the signal processing unit is adapted to implement a neural network for reconstructing images.

According to an advantageous embodiment, the control circuit is adapted to implement the following steps of:
a/ exciting the electrodes, with each electrode being excited by a potential Vₙ^{exc} assuming either the following format:

$${V}_{n}^{exc} ( t ) = A {\sum }_{m = 1}^{{n}_{e}} cos ( 2 π {f}_{m} t ) [ {δ}_{m}^{𝕆} cos ( m {θ}_{n} ) + {δ}_{m}^{𝔼} sin ( \frac{m {θ}_{n}}{2} ) ] \qquad [ Math 2 ]$$

where A is a signal amplitude, ne is the number of electrodes, θₙ is the angular position of the electrode n, fₘ=m*f₀ is an oscillation frequency, f₀ is a fundamental frequency selected such that fₘ is less than the Nyquist frequency of the system for any m, [symbol] is the set of odd natural numbers, [symbol] is the set of even natural numbers;
or the following format:

$${V}_{n}^{exc} ( t ) = - {\sum }_{j = 1}^{n - 1} {[ {V}_{j} ( t ) ]}_{n - 1} + {\sum }_{l = {l}_{n}^{min}}^{{l}_{n}^{max}} {Ψ}_{l} ( t ) , \qquad [ Math 5 ]$$

in which, by convention, a sum is identically zero if the value of the starting index is greater than that of the ending index;
where:

$${Ψ}_{i} ( t ) = A sin ( 2 π {f}_{i} t ) , \qquad [ Math 6 ]$$

$${l}_{n}^{min} = ( n - 1 ) {n}_{e} - \frac{n ( n - 1 )}{2} + 1 , \qquad [ Math 7 ]$$

$$and$$

$${l}_{n}^{max} = n {n}_{e} - \frac{( n + 1 ) n}{2} , \qquad [ Math 8 ]$$

and with [Vⱼ(t)]ₙ₋₁ denoting the (n−1)nth element of the identity defining the voltage Vⱼ(t), subject to the convention whereby the terms ψᵢ are always arranged in increasing order of the indices i in such an identity, with the excitation being carried out either simultaneously over all the electrodes according to [Math 5], or sequentially over one or more sub-sets of electrodes;
b/ measuring electrical properties Vₙ^{meas} of the flow of the fluid with the electrodes;
c/ processing the data derived from the measuring step, step b/, comprising the following sub-steps of:
c1/ computing, for each electrode Eₙ, data points Mₙ defined by:

$${M}_{n} ( k ) = \frac{1}{RP} \vert {\sum }_{p = 0}^{P - 1} {V}_{n}^{meas} ( p ) {e}^{ik {β}_{p}} \vert \qquad [ Math 10 ]$$

where R is the value of the resistance used for measuring Vₙ^{meas} with Vn^{meas}=R Iₙ at the terminals of the resistor, P is the number of points of a discrete sequence of measurements of the current Iₙ, p is the discrete time, k is a Fourier coefficient ranging between 1 and (nₑ−1) and βₚ=(2πp/P);
c2/ forming a matrix of data D from the data points Mₙ(k) for any n and for any k, according to the following equation:

$$D = ( \begin{matrix}\{ {M}_{n} ( 1 ) \} \\ \{ {M}_{n} ( 2 ) \} \\ \{ {M}_{n} ( 3 ) \} \\ ⋮ \\ \{ {M}_{n} ( {n}_{e} - 1 ) \}\end{matrix} ) . \qquad [ Math 13 ]$$

if excitation format [Math 2] is implemented;
or

$$D = ( \begin{matrix}\{ {M}_{n} ( 1 ) \} \\ \{ {M}_{n} ( 2 ) \} \\ \{ {M}_{n} ( 3 ) \} \\ ⋮ \\ \{ {M}_{n} ( \frac{{n}_{e} ( {n}_{e} - 1 )}{2} ) \}\end{matrix} ) , \qquad [ Math 14 ]$$

if excitation format [Math 5] is implemented;
c3/ forming a matrix of signed data, the elements of which are defined by the following equation when the phase shift Φ_{n,l}(k) between the excitation potential at the electrode 1 and the current measured at the electrode n is less than π/2:

$${\tilde{D}}_{n}^{m} = \frac{sin ( {Φ}_{n , l} ( k ) )}{\vert sin ( {Φ}_{n , l} ( k ) ) \vert} {D}_{n}^{m} . \qquad [ Math 20 ]$$

and the elements of which are defined by the following equation when the phase shift Φ_{n,l}(k) between the excitation potential at the electrode 1 and the current measured at the electrode n is greater than or equal to π/2:

$${\tilde{D}}_{n}^{m} = {\sum }_{n}^{m} {D}_{n}^{m} . \qquad [ Math 22 ]$$

where Σ is a matrix of signs defined such that:
if excitation format [Math 2] is implemented, the i-nth element of the j-nth row of Σ is the sign of cosine ([2π/([j+1]/2)]*(i−1)/nₑ) for odd j and the sign of sine ([2π/(j/2)]*(i−1)/nₑ) for even j;
if excitation format [Math 5] is implemented, the opposite sign is assigned to the closest excitation electrode, notably for a measurement electrode located at an equal distance between two excitation electrodes, the amplitude is measured experimentally in order to be of the order of O(10-7) A, corresponding to a negligible contribution to the data.

Preferably, the control circuit is adapted to implement step a/with all the potentials Vₙ^{exc} verifying the following condition:

$${\sum }_{n = 1}^{{n}_{e}} {V}_{n}^{exc} ( t ) = 0 . \qquad [ Math 4 ]$$

According to an advantageous configuration, the electrodes of the electrical sensor are evenly angularly distributed around the body of the fluidic equipment.

A further aim of the invention is the use of the optimization system for measuring cavitation, air bubbles, the absence of fluid and the presence of gas.

A further aim of the invention is an industrial facility, comprising at least one fluidic circuit and an optimization system as described above.

In general, the invention can be implemented in any fluidic circuit, notably in a factory or an industrial production site, in particular in the field of agri-foodstuffs, pharmaceuticals and cosmetics, chemicals and petrochemicals, water distribution and treatment.

The invention therefore basically involves a system for detecting cavitation that is likely to cause excess electrical consumption or excess electrical production or is even likely to break fluidic equipment with a rotary component installed in a fluidic circuit.

The system comprises an electrical sensor with electrodes preferably evenly distributed around a body of the equipment and with the end of said electrodes being flush with the internal wall of the body, preferably as close as possible to the blades of the rotary component.

Electrical Impedance Tomography (EIT) measurements are carried out using either trigonometric or paired electrode signals, implemented simultaneously in order to excite the electrodes.

This non-invasive and non-destructive measurement allows the interior of the body of the fluidic equipment, and therefore the fluid flowing through it, to be viewed continuously and in real time, by measuring the electrical properties (potential and electric current).

The electrical impedance map inside the body is reconstructed by solving the inverse problem.

The acquisition rate of the images reconstructed by the processing unit can be very high, typically up to 31,250 images/second, which means that fluids flowing at a rate of up to 300 meters/second can be observed.

Depending on the signals from the fluid flow that represent cavitation, an electronic unit will automatically modify the operating frequency of the equipment so as to adjust its electrical operating power and thus adjust its flow rate: power ratio.

As a result, the risk of cavitation is eliminated, or at least reduced, and the electrical consumption or the electrical production of the equipment is adapted appropriately.

The invention described above has many advantages, including:
direct measurement of cavitation that is the cause of excess electrical consumption or even a pump breakdown;
rapid detection and possible preventive action, due to the possibility of acquiring measurements/images at a very high rate, up to 31,250 images/second;
a robust system since it is reliable irrespective of the fluid that is used, even under very high pressure, typically up to 300 bar or more, and/or at very high temperatures, typically up to 600° C. or more.

### BRIEF DESCRIPTION OF THE DRAWINGS

FIG. 1 illustrates a fluidic circuit comprising a pump, which can generate cavitation within the fluid flow through the pump, with this cavitation being able to be detected by a system for optimizing electrical consumption according to the invention, comprising an electrical sensor with electrodes for electrical impedance tomography measurement.

FIG. 2 schematically illustrates the hardware and software means of an optimization system according to the invention.

FIG. 3 illustrates a pump body incorporating an electrical sensor of a system according to the invention.

FIG. 3A is a cross-sectional view of a pump body according to FIG. 3, in the vicinity of the electrodes of the electrical sensor.

FIG. 4 illustrates spatial cosine patterns.

FIG. 5 shows part of an electronic circuit for exciting an electrode.

FIG. 6 illustrates a method for generating excitation signals for the electrodes of the electrical sensor according to a first alternative embodiment of the invention.

FIG. 7 illustrates a method for measuring the signals generated by the electrodes.

FIG. 8 shows a graphical representation of the excitation signals and some of their properties.

FIG. 9 illustrates a sign matrix for a 16-electrode electrical sensor.

FIG. 10 illustrates a sign matrix for a 32-electrode electrical transducer.

FIG. 11 illustrates images respectively reconstructed according to the prior art and experimentally, and simulated by a neural network in a system according to the invention.

### DETAILED DESCRIPTION

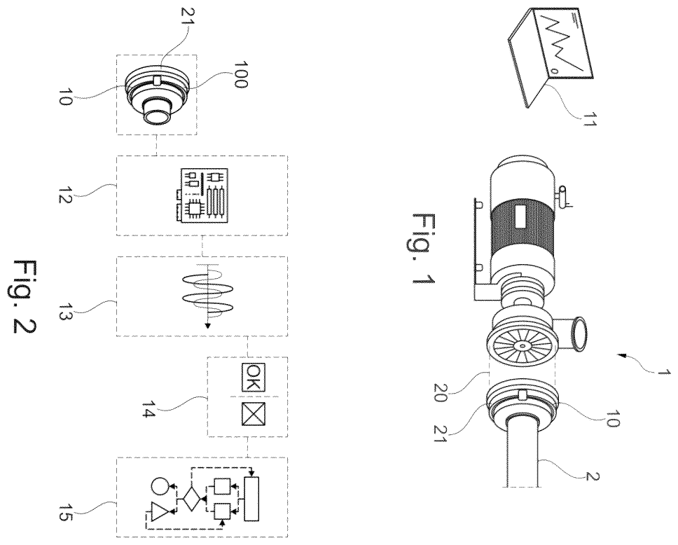

FIG. 1 illustrates an embodiment of a system 1 for optimizing the electrical consumption of a pump 20 moving a fluid in a circuit 2 comprising the pump 20. This system can detect air bubbles due to cavitation, which lead to excess electrical consumption or even to the pump 20 breaking. This system can also use impedance measurement to measure dry running, foreign bodies, blockages, changes in viscosity or other types of faults that can reduce the performance of the pump or block it. The system can also measure internal pump wear in real time and diagnose the hydraulic performance capabilities of the fluidic equipment.

The system 1 firstly comprises an electrical sensor 10, arranged in a body 21 of the pump 2. This electrical sensor 10 allows measurements to be taken of the fluid flow through this body 21 using Electrical Impedance Tomography.

A unit 11 is also provided for operationally controlling the frequency variator of the pump, according to real-time measurements of any faults, so as to prevent cavitation of the pump 20, as a function of representative signals of the fluid flow, as described hereafter.

More specifically, the electrical sensor 10 comprises 16 electrodes 100 distributed, preferably evenly angularly distributed, around the body 21, with the end of said electrodes being flush with the internal surface of the body 21, preferably as close as possible to the end of the pump blades.

The synoptic of the hardware and software means of the system 1 is illustrated in FIG. 2.

The electrodes 100 are connected to a printed circuit 12, which is an electronic circuit for controlling the electrodes 100 and for tomographic measurement by electrical impedance, with the circuit being adapted to respectively simultaneously excite the electrodes and to measure the electrical impedance matrices of the fluid flow including, if applicable, cavitation bubbles in the body 21.

A signal processing unit 13 is used to reconstruct images of the fluid flow in the body 21 from the impedance matrix measurements of the electronic circuit 12.

An electronic automatic control unit 14 is used to control the frequency variator of the pump, preferably by digital communication, based on a risk 13 that may or may not be identified for the pump 20, and more generally is used to monitor the industrial facility in which the fluidic circuit 2 is installed.

By modifying the operating frequency of the pump 20, it is possible to adjust its electrical operating power and thus adjust its flow rate: power ratio.

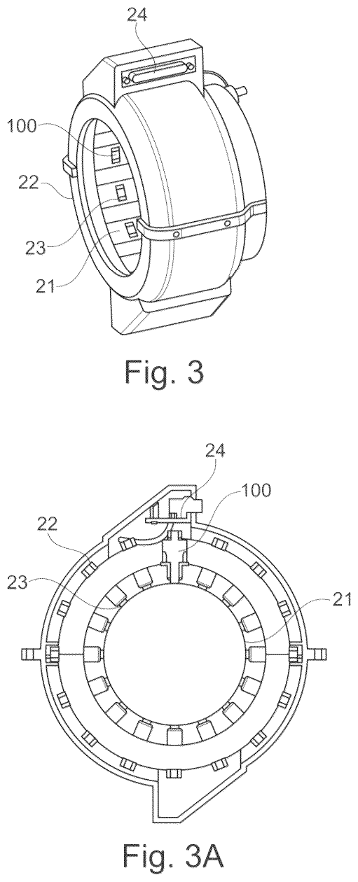

FIGS. 3 and 3A illustrate an advantageous mode of integration in the form of a casing 22 housing an electrical sensor 10 within a fluidic circuit.

A casing 22 fixed around the pump body 21 houses the electrical sensor 10 with the electrodes 100 individually sealably housed and fixed in a through hole 23 in the pipe.

The casing 22 can house an electrical power supply port 24 for the electrodes.

The control circuit 12 can be connected to a data acquisition system. A screen 11 can be used to display the data and the images produced from this data. The data acquisition system contains a Linux operating system (HOST) that controls an FPGA programmable logic array, also contained in the data acquisition system.

The acquisition system is used to generate the analogue excitation signals and to measure the analogue measurement signals originating from the electrodes 100.

The acquisition system can incorporate, for example, a cRIO-9039 controller manufactured by National Instruments and which includes a programmable logic array, NI-9262 modules manufactured by National Instruments for generating analogue excitation signals and NI-9223 modules manufactured by National Instruments for measuring analogue signals originating from the electrodes 100.

The method for measuring and processing signals implemented by the system for detecting faults and preventing failures in the pump according to the invention will now be described.

It should be noted that the electrical sensor 10 is previously installed in the fluidic circuit with the electrodes 100 arranged as indicated above.

### Excitation of the Electrodes

A first step involves simultaneously exciting all the electrodes 100 with a potential assuming an appropriate shape.

The electrodes 100 form a set of linearly independent electrodes. They are used to create electrical excitations on the surface of the body and to measure the electrical properties.

Excitation according to the trigonometric pattern variant [Math 2] is as follows: for a number ne of electrodes, there are (nₑ−1) linearly independent excitation patterns. Fourier basis functions are a natural choice for describing these linearly independent patterns, according to the following equation:

$$\frac{1}{\sqrt{2 π}} {e}^{in θ} \qquad [ Math 1 ]$$

According to a first alternative, all the electrodes are simultaneously excited with trigonometrically shaped excitations.

This set of simultaneous excitations is divided into spatial oscillations according to the Fourier basis and into temporal oscillations.

Various frequencies are imposed in order to distinguish between the various trigonometric signals in frequency multiplexing.

For each trigonometric excitation pattern, each electrode Eₙ is associated with a static voltage Vₙ^{sta}.

The set of ne static voltages Vₙ^{sta} forms a set of sine and cosine functions with different spatial frequencies m.

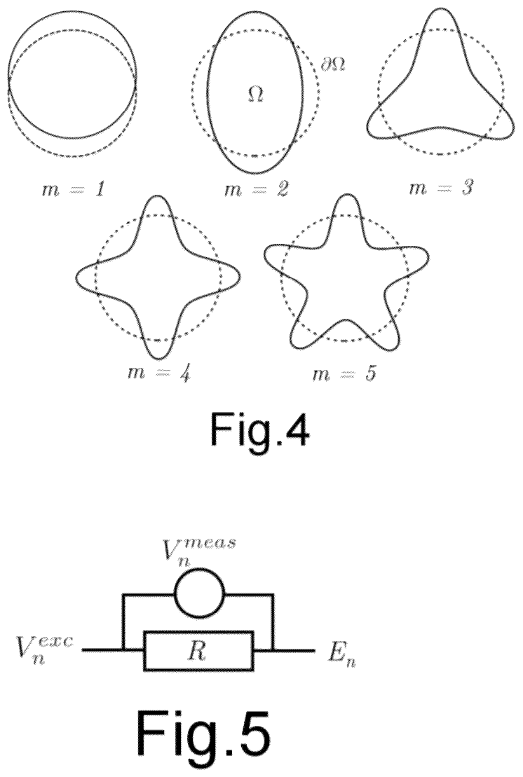

FIG. 4 shows the spatial cosine patterns for m ranging from 1 to 5. The sine patterns are not shown.

The ne electrodes are arranged over the periphery ∂Ω of the body, shown by the dashed lines in FIG. 4. The solid lines represent the excitation potential imposed on the electrodes. The static potential V_{n,m}^{sta} associated with each electrode Eₙ is defined by the following equation, for n ranging between 1 and nₑ:

$${V}_{n}^{exc} ( t ) = A {\sum }_{m = 1}^{{n}_{e}} cos ( 2 π {f}_{m} t ) [ {δ}_{m}^{𝕆} cos ( m {θ}_{n} ) + {δ}_{m}^{𝔼} sin ( \frac{m {θ}_{n}}{2} ) ] \qquad [ Math 2 ]$$

where A is a signal amplitude, m∈1, . . . , (nₑ−1) represents the spatial frequency, nₑ is the number of electrodes, θₙ is the angular position of the electrode n, fₘ=m*f₀ is an oscillation frequency, f₀ is a fundamental frequency selected such that fₘ is less than the Nyquist frequency of the system for any m, [symbol] is the set of odd natural numbers, [symbol] is the set of even natural numbers.

For a given set of nₑ electrodes, all the independent excitation patterns are fully described with (nₑ−1) different spatial frequencies. For the particular case whereby θₙ=2π n/nₑ, the electrodes are evenly distributed over the periphery of the body.

Each spatial frequency m is associated with a temporal frequency fₘ and is simultaneously imposed on each of the electrodes.

Thus, each simultaneous excitation potential Vₙ^{exc} comprises a superposition of (nₑ−1) trigonometric functions, with each function oscillating at a particular frequency fₘ.

The excitation signal of an electrode n is Vₙ^{exc}, defined by the following equation:

$${V}_{n}^{exc} ( t ) = {\sum }_{m = 1}^{{n}_{e}} cos ( 2 π {f}_{m} t ) {V}_{n , m}^{sta} = A {\sum }_{m = 1}^{{n}_{e}} cos ( 2 π {f}_{m} t ) [ {δ}_{m}^{𝕆} cos ( m {θ}_{n} ) + {δ}_{m}^{𝔼} sin ( \frac{m {θ}_{n}}{2} ) ] . \qquad [ Math 3 ]$$

Each potential Vₙ^{exc}(t) thus defined is simultaneously imposed on each electrode Eₙ. The sum of the excitation voltages of the ne electrodes is checked to ensure that it is zero irrespective of the time t. This results in the following condition:

$${\sum }_{n = 1}^{{n}_{e}} {V}_{n}^{exc} ( t ) = 0 . \qquad [ Math 4 ]$$

According to a second alternative of the invention, the excitation format is as follows:

$${V}_{n}^{exc} ( t ) = - {\sum }_{j = 1}^{n - 1} {[ {V}_{j} ( t ) ]}_{n - 1} + {\sum }_{l = {l}_{n}^{min}}^{{l}_{n}^{max}} {Ψ}_{l} ( t ) , \qquad [ Math 5 ]$$

in which, by convention, a sum is identically zero if the value of the starting index is greater than that of the ending index;
where:

$${Ψ}_{i} ( t ) = A sin ( 2 π {f}_{i} t ) , \qquad [ Math 6 ]$$

$${l}_{n}^{min} = ( n - 1 ) {n}_{e} - \frac{n ( n - 1 )}{2} + 1 , \qquad [ Math 7 ]$$

$$and$$

$${l}_{n}^{max} = n {n}_{e} - \frac{( n + 1 ) n}{2} , \qquad [ Math 8 ]$$

and with [Vⱼ(t)]ₙ₋₁ denoting the (n−1)nth element of the identity defining the voltage Vⱼ(t), subject to the convention whereby the terms Ψᵢ are always arranged in increasing order of the indices i in such an identity. The excitation can be carried out simultaneously over all the electrodes or sequentially over one or more sub-sets of electrodes.

### Measuring Electrical Properties

The electrical properties of the fluid flow through section 21 are then measured using the electrodes 100.

The unit 12 controls the programmable logic array of the acquisition system so as to generate 16 excitation signals with the described properties. These 16 digital signals are converted into analogue signals using the NI-9262 modules and are transmitted to the electrodes 100 via coaxial cables.

The printed circuit 12 comprises an excitation circuit for each electrode 100, with each of these circuits comprising a resistor R, as illustrated in FIG. 5. As can be seen in this figure, the potential Vₙ^{exc} is imposed on one side of the resistor R, with the other side being connected to the electrode Eₙ.

The Neumann boundary condition at the electrode Eₙ is the current Iₙ flowing through the excitation circuit. This current is obtained by measuring the voltage Vₙ^{meas}=R Iₙ at the terminals of the resistor. As with Vₙ^{exc}, this signal is a sum of trigonometric functions.

### Data Processing

In a fourth step, the data measured during the second step is processed, either to directly supply information to a processing algorithm, or to obtain a signed data matrix representing an image.

### Generating Data Points Mₙ

In a first sub-step of the fourth step of the measurement method, the data points Mₙ are computed for each electrode n.

The Fourier transform of the measured signal Vₙ^{meas} is computed from a P-point Iₙ(p) current measurement sequence, where p is the discrete time and verifies 0≤p≤P, that is:

$${X}_{n} ( k ) = ℱ [ {I}_{n} ( p ) ] = \frac{θ}{R} {\sum }_{p = 0}^{P - 1} {V}_{n}^{meas} ( p ) {e}^{ik {β}_{p}} \qquad [ Math 9 ]$$

$$where {β}_{p} = \frac{2 π p}{P} , i = \sqrt{- 1} and the normalization factor θ = \frac{1}{P} .$$

The Fourier transform can be computed at the frequency f₁, which corresponds to the frequency at which P Fourier coefficients are computed.

The frequencies fₘ of the voltages Vₙ^{exc} are selected so as to be harmonics of f₁. This allows the measured signals to be distinguished. Thus, each coefficient k is associated with a particular frequency fₘ.

The data is then generated at a frequency f₁ and the resolution in the Fourier space is Δf=fₘ₊₁−fₘ=f₁. It should be noted that the highest frequency is selected so as to be less than the Nyquist frequency of the system f_{Nyq}=½ Δp, where Δp is the sampling time. The data points Mₙ(k) are the moduli of each Fourier coefficient k for each electrode n:

$${M}_{n} ( k ) = \frac{1}{RP} \vert {\sum }_{p = 0}^{P - I} {V}_{n}^{meas} ( p ) {e}^{ik {β}_{p}} \vert \qquad [ Math 10 ]$$

where R is the value of the resistance used for measuring Vₙ^{meas} with Vₙ^{meas}=R Iₙ at the terminals of the resistor, P is the number of points of a discrete sequence of measurements of the current Iₙ, p is the discrete time, k is a Fourier coefficient ranging between 1 and (nₑ−1) and βₚ=(2πp/P).

Each data point defines the current of a given trigonometric pattern for a given electrode. The set of data points Mₙ(k) for any n and any k forms the measurement data.

The excitation frequencies are determined as follows. The sampling frequency f_{DAQ} of the data acquisition system limits the maximum frequency fₘ of the voltages Vₙ^{exec}, with the Nyquist frequency f_{Nyq}=f_{DAQ}/2 forming an upper limit.

For a data acquisition system such that f_{DAQ}=1 MS/s, the Nyquist frequency is 500 kHz.

In order to benefit from the small residual voltage errors resulting from the energy stored in the electrode-electrolyte contact impedance, continuous signals must be provided. In order to generate continuous signals at different frequencies, the signals are selected so as to be harmonics of the lowest generated frequency f₁.

When the potential is no longer imposed on an electrode, some of the electrical energy is stored for a few tens of microseconds at the interface between the electrode and the medium. This contact impedance phenomenon leads to a measurement error and means that a dead time must be introduced between two successive excitations in order to wait for this energy to dissipate. The advantage of generating continuous signals is that the imposed voltages are never de-excited, thus avoiding the errors associated with contact impedance and the need to introduce dead times.

With 16 electrodes, a set of excitation signals is generated at 15 different frequencies (according to [Math 2]) and at 120 different frequencies (according to [Math 5]). Considering the sampling rate of the acquisition system, for example, 1 MS/s, the frequencies can be selected such that fᵢ=i*f₀, where f₀ is the fundamental frequency and i ranges between 1 and 15 or 1 and 120, respectively.

Furthermore, in the case with 15 frequencies, the discrete Fourier transforms can be selected so as to be performed at P=32 points because only positive results are considered. This results in an image data acquisition rate of 1*10⁶/32=31,250 images per second. This selection implies that the lowest sine signal frequency f₁ is equal to the computation frequency of the discrete Fourier transforms, and that the highest frequency f₁₅=15*f₀=468.875 kHz, that is, below the Nyquist limit of 500 kHz for the considered system.

The excitation amplitudes are determined as follows.

The voltage generation and acquisition modules operate within a range of ±10 V. Considering the voltages Vₙ^{exc}, the amplitude A of the sines must be significantly lower than the sum of the generated sines due to constructive interference. However, the amplitude A of the signal must be as large as possible in order to minimize the signal-to-noise ratio.

Another limit to consider is the maximum variation allowed between two successively generated potentials. Real-time control in the acquisition system allows a satisfactory value of A=0.15 V to be selected, yielding resonant peaks of ±2.25 V. The rapid transition between positive and negative signal values prevents the appearance of electrolytic effects. For example, a phenomenon of electrolysis in water occurs when a DC voltage of more than 1.2 V is applied. This phenomenon does not occur for AC voltages of more than 1.2 V if these voltages vary quickly enough.

### Obtaining a Data Matrix D

In a second sub-step, a data matrix D is obtained from the data points Mₙ.

For the considered system with 16 electrodes using the NI-9223 modules, a fixed-point data format of 20 bits allocated to the number, including 5 bits for precision digits, can be used. The electrode index n, ranging between 1 and 16, and the Fourier coefficient k, ranging between 1 and 15, can be described by 4-bit coded binary numbers.

For a system with 32 electrodes, each data point module Mₙ(k) is coded with the numbers n and k in the following format:

$${M}_{n} ( k ) = {\underbrace{〈 + , 8 , 0 〉}}_{k} + {\underbrace{〈 + , 8 , 0 〉}}_{n} + {\underbrace{〈 \pm , 16 , 11 〉}}_{M} , \qquad [ Math 11 ]$$

where the fixed-point format <s, b, p> is used with s meaning signed/unsigned; b being the number of allocated bits; and p being the number of bits for precision. The data Mₙ(k) is encoded in U32 format.

The ne data points measured on the ne electrodes for a given Fourier coefficient k, i.e., for a given frequency fₘ, yield the following data vector:

$$\{ {M}_{n} ( k ) \} = ( {M}_{1} ( k ) {M}_{2} ( k ) {M}_{3} ( k ) … {M}_{{n}_{e}} ( k ) ) \qquad [ Math 12 ]$$

where the Mₙ(k) are integers encoded in U32 format.

The nₑ−1 vectors can be concatenated into a data matrix D:

$$D = ( \begin{matrix}\{ {M}_{n} ( 1 ) \} \\ \{ {M}_{n} ( 2 ) \} \\ \{ {M}_{n} ( 3 ) \} \\ ⋮ \\ \{ {M}_{n} ( {n}_{e} - 1 ) \}\end{matrix} ) \qquad [ Math 13 ]$$

if excitation format [Math 2] is implemented,
where

$$D = ( \begin{matrix}\{ {M}_{n} ( 1 ) \} \\ \{ {M}_{n} ( 2 ) \} \\ \{ {M}_{n} ( 3 ) \} \\ ⋮ \\ \{ {M}_{n} ( \frac{( {n}_{e} - 1 )}{2} ) \}\end{matrix} ) \qquad [ Math 14 ]$$

if excitation format [Math 5] is implemented.

The data size is then S=nₑ (nₑ−1).

Only the Fourier transform moduli form part of the data.

For one image, the data size is S*32 bits=4 kB. By comparison, the method described in publications [2], [3], [4] results in 127 kB of data for one image, without any additional information concerning the boundary conditions.

Thus, the measurement method implemented by the system according to the invention allows a higher image acquisition rate to be provided and also allows the size of the data to be reduced by a factor n_{e/2} compared with the method described in publications [2], [3], [4].

### Obtaining a Signed Data Matrix

In a third sub-step, a signed data matrix is obtained, which represents an image.

The Fourier transforms provide a modulus and a phase. The sign of each data point is estimated from the phase.

Thus, considering an excitation signal imposed on each electrode Eₙ at a frequency fₘ in the following format:

$${V}_{n , m}^{exc} ( t ) = A cos ( 2 π {f}_{m} t ) [ {δ}_{m}^{𝕆} cos ( m {θ}_{n} ) + {δ}_{m}^{𝔼} sin ( \frac{m {θ}_{n}}{2} ) ] , \qquad [ Math 15 ]$$

the phase of the signal is expressed as:

$${ϕ}_{n}^{V} ( k ) = arctan ( \frac{- {\sum }_{p = 0}^{P - 1} {V}_{n , m}^{meas} ( p ) sin ( k {β}_{p} )}{{\sum }_{p = 0}^{P - 1} {V}_{n , m}^{meas} ( p ) cos ( k {β}_{p} )} ) . \qquad [ Math 16 ]$$

The phase of the current Iₗ^{meas}(t) measured on the electrode Eₗ at the frequency fₘ is:

$${ϕ}_{l}^{I} ( k ) = arctan ( \frac{- {\sum }_{p = 0}^{P - 1} {I}_{l}^{meas} ( p ) sin ( k {β}_{p} )}{{\sum }_{p = 0}^{P - 1} {I}_{l}^{meas} ( p ) cos ( k {β}_{p} )} ) . \qquad [ Math 17 ]$$

Assuming synchronous sampling between the input of the analogue signal AI and the output of the sampled signal AO, the phase shift between the excitation potential and the measured current is:

$${Φ}_{n , l} ( k ) = {ϕ}_{n}^{I} ( k ) - {ϕ}_{l}^{V} ( k ) . \qquad [ Math 18 ]$$

The phase shift depends on the design of the EIT sensors and on the nature of the flow inside the body. If the phase shift is significant, wrap-around effects may make it impossible to reconstruct the sign of the data. Indeed, the phase is symmetrical to a 2πN transformation, where N is an integer. If the phase is greater than 2π, it is wrapped around itself.

The following two cases have been identified:

$$\vert {Φ}_{n , l} ( k ) \vert < \frac{π}{2} et \vert {Φ}_{n , l} ( k ) \vert \geq π / 2 . \qquad [ Math 19 ]$$

In the first case, the sign of the data points is computed from the previous equation. The element of the signed data matrix corresponding to the k-nth Fourier coefficient and the n-nth electrode is then:

$${\tilde{D}}_{n}^{m} = \frac{sin ( {Φ}_{n , l} ( k ) )}{\vert sin ( {Φ}_{n , l} ( k ) ) \vert} {D}_{n}^{m} . \qquad [ Math 20 ]$$

In the second case, the wrap-around effects prevent the sign of Dₙ^{k} from being estimated. A sign matrix Σ is then introduced in order to allocate an arbitrary sign to the data.

The sign matrix Σ is estimated from the sign of the excitation signal at t=0 for a given harmonic for a given electrode by introducing the following sign function:

$${\sum }_{n , m} = \{ \begin{matrix}1 & if {V}_{n}^{meas} > 0 , \\ 0 & if {V}_{n}^{meas} = 0 , \\ - 1 & if {V}_{n}^{meas} < 0 ,\end{matrix} \qquad [ Math 21 ]$$

with Vₙ^{meas} as defined above.

The sign matrix Σ is more specifically defined so that its rows represent the signs of a cosine function alternating with those of a sine function with an integer number of periods on each row. The first two rows have a single period and the number of periods increases by one unit for each subsequent pair of rows.

In other words, if excitation format [Math 2] is implemented, the rows of the sign matrix Σ are defined such that the i-nth element of the j-nth row is the sign of cosine ([2π/([j+1]/2)]*(i−1)/nₑ) for odd j and the sign of sine ([2π/(j/2)]*(i−1)_{/ne}) for even j.

For example, the first element of the first row of the sign matrix is the sign of cosine (0), that is, +. Where the number of electrodes nₑ is equal to 16, the sign of the fifth element of the first row is the sign of cosine (2π*[4/16]), that is, 0.

Thus, the first row of the sign matrix represents the signs of a period of a cosine function, that is, the sign of cosine (2π*(i−1)/nₑ) for the i-nth element of the row. The second row represents the signs of one period of a sine function, that is, the signs of sine (2π*(i−1)/nₑ). The third row represents the signs of two periods of a cosine function, that is, the signs of cosine ([2π/2]*(i−1)/nₑ). The fourth row represents the signs of two periods of a sine function, that is, the signs of sine ([2π/2]*(i−1)/nₑ). The fifth row represents the signs of three periods of a cosine function, that is, the signs of cosine ([2π/3]*(i−1)/ne), and so on up to the (nₑ−1)-nth row.

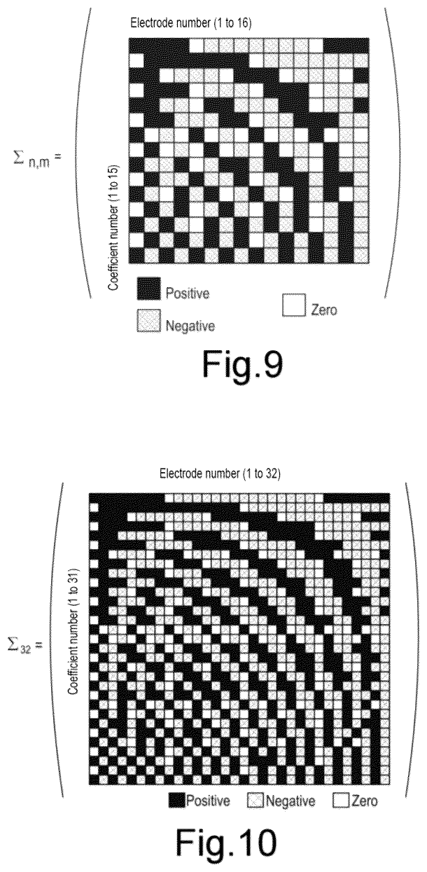

For example, for a device with 16 electrodes, the sign matrix assumes the format shown in FIG. 9. For a device with 32 electrodes, the sign matrix assumes the format shown in FIG. 10.

If excitation format [Math 5] is implemented, the opposite sign is assigned to the closest excitation electrode, notably for a measurement electrode located at an equal distance between two excitation electrodes. The amplitude is experimentally measured in order to be of the order of O(10-7) A, corresponding to a negligible contribution to the data. The use of such a sign matrix optimizes data processing for forming an image. It allows the sign of each data point to be estimated and an image to be reconstructed.

For a significant phase shift, i.e., greater than or equal to π/2, the arbitrarily signed amplitudes of the nₑ−1 excitation patterns of the ne electrodes, in other words, the elements of the signed data matrix corresponding to the k-nth Fourier coefficient and the n-nth electrode, are provided by:

$${\tilde{D}}_{n}^{m} = {\sum }_{n}^{m} {D}_{n}^{m} . \qquad [ Math 22 ]$$

### Algorithmic Implementation

The HOST part of the acquisition system continuously sends the frequency and amplitude parameters to the FPGA of the acquisition system.

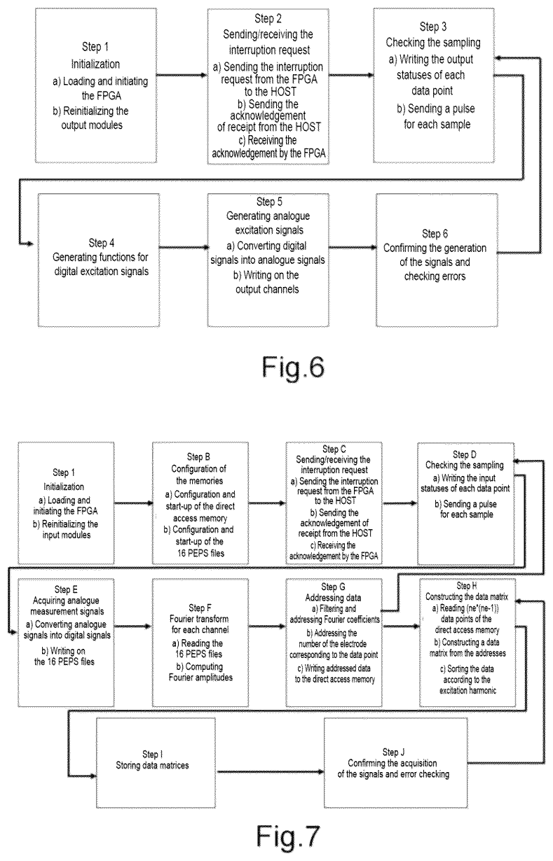

FIG. 6 illustrates an algorithm for generating excitation signals for the 16 electrodes.

With the considered system, the FPGA receives the data points 16 by 16 in a loop rated at 1 MS/s in order to create 16 analogue signals.

In a first step, the system is initialized.

Initially, the FPGA is empty. The HOST loads the FPGA and then the NI-9262 modules are reset.

In a second step, an interruption request is sent and received.

A hardware interruption is used to notify the HOST when the FPGA is ready to start acquiring data. The FPGA waits for validation from the HOST before starting acquisition.

In a third step, a sampling check is performed.

A sample pulse generation function is evoked to start generating data points. The frequency at which the function is evoked determines the sampling rate for generating data points. At the same time, an I/O status write function is evoked at the same frequency in order to check the status of each generated sample.

In a fourth step, digital excitation signal functions are generated.

The HOST commands the FPGA to start generating excitation signal functions.

In a fifth step, the analogue excitation signals are generated. The sixteen excitation signals are sent to the electrodes.

In a sixth step, the HOST confirms that the signals have been generated and indicates any errors in the HOST or the FPGA.

Steps 1 and 2 are performed once when the algorithm is initiated. Steps 3 to 6 are repeated for each output point at the sampling frequency.

The sampling frequency can range between 10 kHz and 500 MHz, preferably between 500 kHz and 50 MHz.

FIG. 7 shows an algorithm for processing the data received from the electrodes 100.

By measuring the voltages at the terminals of the resistors R, it is possible to deduce the Neumann boundary conditions for implementing the image reconstruction algorithm. The acquisition rate of 1 MS/s over 16 channels corresponds to a data transfer rate of 320 MB/s.

The use of fast Fourier transforms, considering only the Fourier coefficients linked to a generated signal, allows the size of the data to be reduced without affecting the quality thereof. It also acts as an effective band filter. However, computing 16 fast Fourier transforms in real time requires high computing capacity. The FPGA, which allows signals to be transformed in real time and at the same time into their Fourier components over several channels, is a suitable tool for carrying out this task.

In a first step A, the system is initialized.

The FPGA resets the NI-9223 analogue signal acquisition modules.

In a second step B, the memories are configured.

The HOST configures and starts direct access to the FPGA memory. The FPGA configures and starts sixteen first-in-first-out queues to ensure that the sixteen measurement channels are connected with their Fast Fourier Transform computations.

In a third step C, an interruption request is sent and received.

A hardware interruption ensures that the queues and direct access to the memory are ready.

In a fourth step D, the sampling is verified.

A sample pulse generation function is evoked to control the sampling rate and an I/O status read function is evoked at the same frequency to check the status of each sample and notify the HOST of any errors.

In a fifth step E, the analogue measurement signals are acquired.

The I/O read function is configured to read a single sample from each channel of each NI-9223 module. This function is evoked at 1 MHz and is regulated by the sample pulse generation function.

In a sixth step F, the Fast Fourier Transform of each channel is computed in a loop at 1 MHz. The computation time is determined by the number P of points considered for the Fourier transform. Once the P measured data points have been transferred for the Fourier transform computations, the function restores the P Fourier coefficients one by one for each iteration of the Fourier transform loop. In a second phase, the amplitudes of the Fourier coefficients are computed at a frequency of 1 MHz.

In a seventh step G, the data is addressed.

The amplitude data points in U32 format together with the corresponding Fourier coefficient (in U16 format) and the corresponding channel (in U16 format) form a data element in U64 format. For each iteration of the Fourier transform loop, 16 elements for the 16 channels are written to the direct access memory in order to be transmitted to the HOST.

In an eighth step H, the data matrix is constructed.

The HOST waits for the direct access memory to collect at least 240 elements, representing a complete data image. The address of the n-nth electrode and the Fourier coefficient associated with the amplitude are used to form the data matrix D.

In a ninth step I, the data matrices are stored.

The data is used to perform a real-time image reconstruction or to be stored. The image is based on a one-step iterative least squares reconstruction algorithm, for example, the algorithm described in publication [5].

Real-time image reconstruction can generate of the order of a hundred images per second.

In a tenth step J, signal acquisition is confirmed and an error check is performed.

The synchronization of the modules for generating and measuring analogue signals is checked and any errors are reported.

Steps A to C are performed once when the algorithm is initiated.

Steps D to G are repeated for each output point at the sampling rate.

Once a complete data matrix containing nₑ*(nₑ−1) data points is acquired, the algorithm transitions to step H. Steps H to J are repeated at the image acquisition rate.

The sampling frequency can range between 10 kHz and 500 MHz, preferably between 500 kHz and 50 MHz.

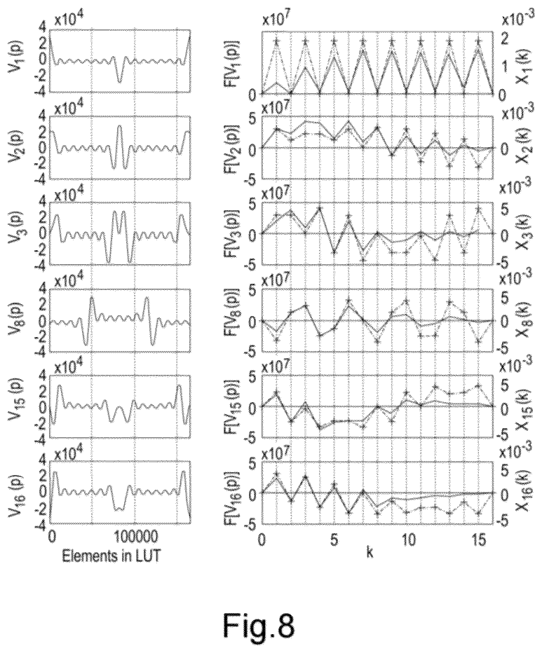

FIG. 8 shows, on the graphs on the left, the excitation signals for six of the sixteen electrodes. Each signal is made up of a sum of 15 sine functions.

The solid lines in the graphs on the right of FIG. 8 represent, in the equivalent Fourier space, the amplitudes of the measured voltages V^{meas} on the resistors R shown in FIG. 2, with R=200 Ω. The dashed lines represent the Fourier transforms of the voltages of the generated signals.

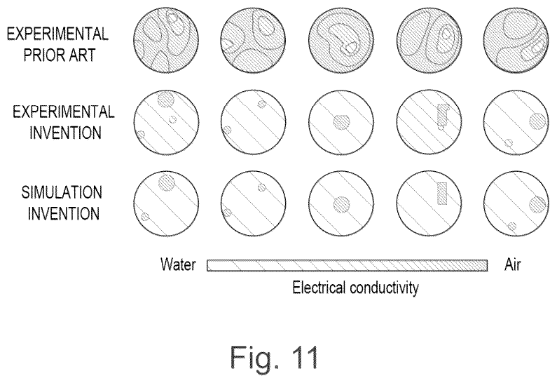

FIG. 11 shows the experimental images obtained by neural network reconstruction, based on the aforementioned measurement matrices, of a water flow containing air bubbles, according to the invention and, by way of comparison, the experimental images according to the prior art. It is clear that the detection according to the invention is much more accurate than according to the prior art and almost perfectly corresponds to the experimental situation.

Depending on the signals from the fluid flow representing one or more cavitations, the electronic automatic control unit 14 may or may not modify the operating frequency of the pump 20, or even interrupts it, so as to avoid any excess electrical consumption and, if applicable, to prevent the pump 20 from breaking.

The invention is not limited to the examples described above; in particular, it is possible to combine features of the illustrated examples within alternative embodiments that are not illustrated.

Other alternative embodiments and improvements can be contemplated without departing from the scope of the invention. In particular, the method implemented by the system according to the invention can use acquisition systems other than the one described.

If, in the illustrated example, the number of sensor electrodes is equal to 16 or 32, a smaller number, notably 4 or 12 electrodes, or a number greater than 32, can be contemplated.

### LIST OF CITED REFERENCES

[1] Teague, G. (2002). Mass flow measurement of multi-phase mixtures by means of tomographic techniques. University of Cape Town, Faculty of Engineering, Department of Electrical Engineering.
[2] Dupré, A., Mylvaganam, S. (2017). Simultaneous and Continuous Excitation Strategy for High Speed EIT: the ONE-SHOT method. In Proceedings of the 9th World Congress on Industrial Process Tomography, pages 667-674.
[3] Darnajou, M., Dupré, A., Dang, C., Ricciardi, G., Bourennane, S., Bellis, C. (2019). On the implementation of simultaneous multi-frequency excitations and measurements for electrical impedance tomography. Sensors, 19 (17).
[4] Darnajou, M., Dupré, A., Dang, C., Ricciardi, G., Bourennane, S., Bellis, C., Mylvaganam, S. (2020). High Speed EIT with Multifrequency Excitation using FPGA and Response Analysis using FDM. IEEE Sensors.

[5] https://www.math.colostate.edu/~siamcsu/files/NOSER.pdf

1. A system for optimizing the electrical consumption or the electrical production of fluidic equipment with at least one rotary component, adapted to be electrically powered or to produce electricity, comprising:
at least one electrical sensor comprising a plurality of electrodes distributed around a body of the fluidic equipment, with the end of said electrodes being flush with the internal surface of the body and facing the rotary component;
an electronic circuit for controlling the electrodes and for tomographic measurement by electrical impedance, the circuit being adapted to respectively simultaneously excite the electrodes and to measure electrical impedance matrices of the fluid flow comprising, eventually, cavitation bubbles in the body;
a signal processing unit, adapted to reconstruct images of the fluid flow in the body from the measurements of impedance matrices of the electronic circuit;
an electronic unit for automatically controlling the component for controlling the fluidic equipment, adapted to modify the operating frequency of the equipment so as to adjust its electrical operating power and thus adjust its flow rate: power ratio.

2. The optimization system as claimed in claim 1, the fluidic equipment being a pump or a turbine, the end of the electrodes facing the free end of the blades of the pump or the turbine or being integrated with them, the control component being a frequency variator.

3. The optimization system as claimed in claim 1, the operation of the electronic unit for automatically controlling the fluidic equipment being slaved to that of the signal processing unit.

4. The optimization system as claimed in claim 1, comprising a casing fixed around the body of the fluidic equipment, housing the electrical sensor with the electrodes being individually sealably housed and fixed in a through hole of the body.

5. The optimization system as claimed in claim 4, the casing housing an electrical power supply port for the electrodes.

6. The optimization system as claimed in claim 1, the signal processing unit being adapted to implement a neural network for reconstructing images.

7. The optimization system as claimed in claim 1, the control circuit being adapted to implement the following steps of:
a/ exciting the electrodes, with each electrode being excited by a potential Vₙ^{exc} assuming either the following format:
$${V}_{n}^{exc} ( t ) = A {\sum }_{m = 1}^{{n}_{e}} cos ( 2 π {f}_{m} t ) [ {δ}_{m}^{𝕆} cos ( m {θ}_{n} ) + {δ}_{m}^{𝔼} sin ( \frac{m {θ}_{n}}{2} ) ] \qquad [ Math 2 ]$$
where A is a signal amplitude, m∈1, . . . , (nₑ−1) represents the spatial frequency, nₑ is the number of electrodes, θₙ is the angular position of the electrode n, fₘ=m*f₀ is an oscillation frequency, f₀ is a fundamental frequency selected such that fₘ is less than the Nyquist frequency of the system for any m, [symbol] is the set of odd natural numbers, [symbol] is the set of even natural numbers;
or the following format:
$${V}_{n}^{exc} ( t ) = - {\sum }_{j = 1}^{n - 1} {[ {V}_{j} ( t ) ]}_{n - 1} + {\sum }_{l = {l}_{n}^{min}}^{{l}_{n}^{max}} {Ψ}_{l} ( t ) , \qquad [ Math 5 ]$$
in which, by convention, a sum is identically zero if the value of the starting index is greater than that of the ending index;
where:
$${Ψ}_{i} ( t ) = A sin ( 2 π {f}_{i} t ) , \qquad [ Math 6 ]$$
$${l}_{n}^{min} = ( n - 1 ) {n}_{e} - \frac{n ( n - 1 )}{2} + 1 , \qquad [ Math 7 ]$$
$$and$$
$${l}_{n}^{max} = n {n}_{e} - \frac{( n + 1 ) n}{2} , \qquad [ Math 8 ]$$
and with [Vⱼ(t)]ₙ₋₁ denoting the nth element of the identity defining the voltage Vⱼ(t) subject to the convention whereby the terms ψ₁ are always arranged in increasing order of the indices i in such an identity, with the excitation being carried out either simultaneously over all the electrodes according to [Math 5], or sequentially over one or more sub-sets of electrodes;
b/ measuring electrical properties Vₙ^{meas} of the flow of the fluid with the electrodes;
c/ processing the data derived from the measuring step, step b/, comprising the following sub-steps of:
c1/ computing, for each electrode Eₙ, data points Mₙ defined by:
$${M}_{n} ( k ) = \frac{1}{RP} \vert {\sum }_{p = 0}^{P - 1} {V}_{n}^{meas} ( p ) {e}^{ik {β}_{p}} \vert \qquad [ Math 10 ]$$
where R is the value of the resistance used for measuring Vₙ^{meas} with Vₙ^{meas}=R Iₙ at the terminals of the resistor, P is the number of points of a discrete sequence of measurements of the current Iₙ, p is the discrete time, k is a Fourier coefficient ranging between 1 and (nₑ−1) and βₚ=(2πp/P);
c2/ forming a matrix of data D from the data points Mₙ(k) for any n and for any k, according to the following equation:
$$D = ( \begin{matrix}\{ {M}_{n} ( 1 ) \} \\ \{ {M}_{n} ( 2 ) \} \\ \{ {M}_{n} ( 3 ) \} \\ ⋮ \\ \{ {M}_{n} ( {n}_{e} - 1 ) \}\end{matrix} ) . \qquad [ Math 13 ]$$
if excitation format [Math 2] is implemented;
or
$$D = ( \begin{matrix}\{ {M}_{n} ( 1 ) \} \\ \{ {M}_{n} ( 2 ) \} \\ \{ {M}_{n} ( 3 ) \} \\ ⋮ \\ \{ {M}_{n} ( \frac{{n}_{e} ( {n}_{e} - 1 )}{2} ) \}\end{matrix} ) , \qquad [ Math 14 ]$$
if excitation format [Math 5] is implemented;
c3/ forming a matrix of signed data, the elements of which are defined by the following equation when the phase shift Φ_{n,l}(k) between the excitation potential at the electrode 1 and the current measured at the electrode n is less than π/2:
$${\tilde{D}}_{n}^{m} = \frac{sin ( {Φ}_{n , l} ( k ) )}{\vert sin ( {Φ}_{n , l} ( k ) ) \vert} {D}_{n}^{m} . \qquad [ Math 20 ]$$
and the elements of which are defined by the following equation when the phase shift Φ_{n,l}(k) between the excitation potential at the electrode 1 and the current measured at the electrode n is greater than or equal to π/2:
$${\tilde{D}}_{n}^{m} = {\sum }_{n}^{m} {D}_{n}^{m} . \qquad [ Math 22 ]$$
where Σ is a matrix of signs defined such that:
if excitation format [Math 2] is implemented, the i-nth element of the j-nth row of Σ is the sign of cosine ([2π/([j+1]/2)]*(i−1)/nₑ) for odd j and the sign of sine ([2π/(j/2)]*(i−1)/nₑ) for even j;
if excitation format [Math 5] is implemented, the opposite sign is assigned to the closest excitation electrode, notably for a measurement electrode located at an equal distance between two excitation electrodes, the amplitude is measured experimentally in order to be of the order of O(10-7)A, corresponding to a negligible contribution to the data.

8. The optimization system as claimed in claim 7, the control circuit being adapted to implement step a/ with all the potentials Vₙ^{exc} verifying the following condition:
$${\sum }_{n = 1}^{{n}_{e}} {V}_{n}^{exc} ( t ) = 0. \qquad [ Math 4 ]$$

9. The optimization system as claimed in claim 1, the electrodes of the electrical sensor being evenly angularly distributed around the body of the fluidic equipment.

10. The use of the optimization system as claimed in claim 1 for measuring cavitation, air bubbles, the absence of fluid and the presence of gas.

11. An industrial facility, comprising at least one fluidic circuit and an optimization system as claimed in claim 1.
